(19) United States
(12) Patent Application Publication
(10) Pub. No.: US 2020/0184075 A1
(43) Pub. Date: Jun. 11, 2020

(54) IMAGE FORMING APPARATUS, VIRUS CHECKING METHOD AND NON-TRANSITORY COMPUTER-READABLE RECORDING MEDIUM ENCODED WITH VIRUS CHECKING PROGRAM

(71) Applicant: KONICA MINOLTA, INC., Tokyo (JP)

(72) Inventors: Kazuhiro TOMIYASU, Toyokawa-shi (JP); Kaoru FUKUOKA, Toyokawa-shi (JP); Hiroaki SUGIMOTO, Nagoya-shi (JP)

(73) Assignee: KONICA MINOLTA, INC., Tokyo (JP)

(21) Appl. No.: 16/674,412

(22) Filed: Nov. 5, 2019

(30) Foreign Application Priority Data
Dec. 6, 2018 (JP) 2018-229460

(51) Int. Cl. G06F 21/56; G06F 21/60; H04L 29/06; G06F 21/55

(52) U.S. Cl. CPC G06F 21/566; G06F 21/554; H04L 63/145; G06F 21/608

(57) ABSTRACT

An image forming apparatus to which an external storage device is attachable and from which the external storage device is detachable, includes a hardware processor, wherein the hardware processor, in response to detection of attachment of the external storage device, checks presence of a computer virus in a plurality of data pieces stored in the external storage device, determines a target data piece to be processed from among the plurality of data pieces stored in the external storage device, and in response to determination of the target data piece while the plurality of data pieces stored in the external storage device are being checked, checks presence of a computer virus in such a manner that the target data piece is given a higher priority than other data pieces.

The entire disclosure of Japanese patent Application No. 2018-229460 filed on Dec. 6, 2018 is incorporated herein by reference in its entirety.

### BACKGROUND

### Technological Field

The present invention relates to an image forming apparatus, a virus checking method and a non-transitory computer-readable recording medium encoded with a virus checking program. In particular, the present invention relates to an image processing apparatus to which an external storage device is attachable and from which the external storage is detachable, a virus checking method executed in the image forming apparatus and a non-transitory computer-readable recording medium encoded with a virus checking program that causes a computer controlling the image forming apparatus to execute the virus checking method.

### Description of the Related Art

In recent years, the data to be processed in a plurality of Multi Function Peripherals (hereinafter referred to as “MFPs”) is input from outside. For example, the MFPs may download the data from a computer connected to the Internet for processing. In this case, the MFPs are exposed to the threat of computer viruses. Thus, it is necessary to execute a virus checking process of checking presence of computer viruses in the data input to the MFPs.

Japanese Patent Laid-Open No. 2006-256104 describes an image forming apparatus, in the case where the data received from a client PC is held in a memory, when a control program executed by a main CPU detects a virus intermixed in the held data, characterized by being configured to notify a panel of intermixture of the virus and preventing secondary infection with the virus intermixed in data stored in the memory.

In recent years, an external storage device such as a USB (Universal Serial Bus) memory is attachable to and detachable from an MFP, and the data stored in the USB memory may be infected with a virus. Thus, it is necessary to execute a virus checking process on the data stored in the USB memory.

However, in the case where the virus checking process is executed on all of the data stored in the USB memory, there is a problem that the MFP cannot process the data stored in the USB memory until the virus checking process is completed, and the user has to wait.

### SUMMARY

According to one aspect of the present inventions, an image forming apparatus to which an external storage device is attachable and from which the external storage device is detachable, includes a hardware processor, wherein the hardware processor, in response to detection of attachment of the external storage device, checks presence of a computer virus in each of a plurality of data pieces stored in the external storage device, determines a target data piece to be processed from among the plurality of data pieces stored in the external storage device, and in response to determination of the target data piece while the plurality of data pieces stored in the external storage device are being checked, checks presence of a computer virus in such a manner that the target data piece is given a higher priority than other data pieces.

According to another aspect of the present inventions, a virus checking method is executed in an image forming apparatus to which an external storage device is attachable and from which the external storage device is detachable, wherein the virus check method includes a checking step of checking presence of a computer virus in each of a plurality of data pieces stored in the external storage device in response to detection of attachment of the external storage device, and a target determining step of determining a target data piece to be processed from among the plurality of data pieces stored in the external storage device, and the checking step includes checking presence of a computer virus in such a manner that the target data piece is given a higher priority than other data pieces, in response to determination of the target data piece while the plurality of data pieces stored in the external storage device are being checked.

According to yet another aspect of the present inventions, a non-transitory computer-readable recording medium is encoded with a virus checking program executed in a computer controlling an image forming apparatus to which an external storage device is attachable and from which the external storage device is detachable, wherein the virus checking program causes the computer to execute a checking step of checking presence of a computer virus in each of a plurality of data pieces stored in the external storage device in response to detection of attachment of the external storage device, and a target determining step of determining a target data piece to be processed from among the plurality of data pieces stored in the external storage device, and the checking step includes checking presence of a computer virus in such a manner that the target data piece is given a higher priority than other data pieces, in response to determination of the target data piece while the plurality of data pieces stored in the external storage device are being checked.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing the appearance of an MFP;

FIG. 2 is a block diagram showing the outline of a hardware configuration of the MFP;

FIG. 3 is a block diagram showing one example of the functions of a CPU included in the MFP;

FIG. 4 is a first diagram showing one example of a scan table;

FIG. 5 is a diagram showing one example of risk level information;

FIG. 6 is a second diagram showing one example of the scan table;

FIG. 7 is a diagram showing one example of history information;

FIG. 8 is a third diagram showing one example of the scan table;

FIG. 9 is a fourth diagram showing one example of the scan table;

FIG. 10 is a flow chart showing one example of a flow of a definition file acquisition process;

FIG. 11 is a flow chart showing one example of a flow of a virus checking process;

FIG. 12 is a flow chart showing one example of a flow of an order determination process;

FIG. 13 is a flow chart showing one example of a flow of a target data checking process; and

FIG. 14 is a flow chart showing one example of a flow of a process control process.

### DETAILED DESCRIPTION OF EMBODIMENTS

Hereinafter, one or more embodiments of the present invention will be described with reference to the drawings. However, the scope of the invention is not restricted to the disclosed embodiments.

In the following description, the same parts are denoted with the same reference characters. Their names and functions are also the same. Thus, a detailed description thereof will not be repeated.

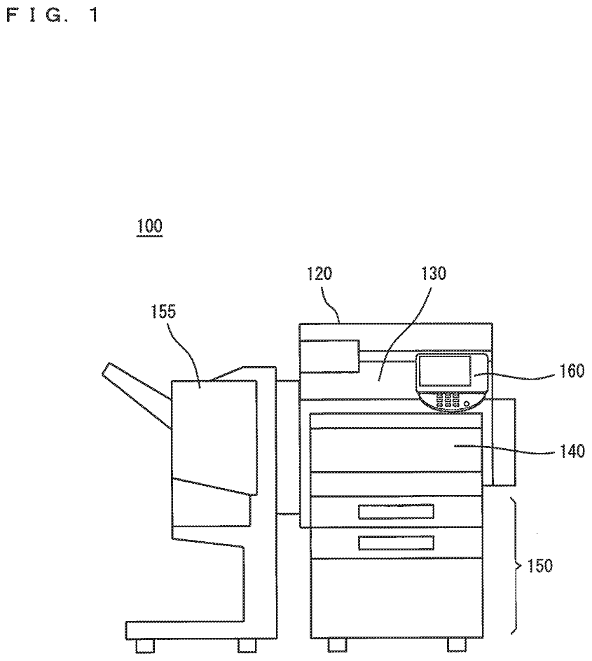

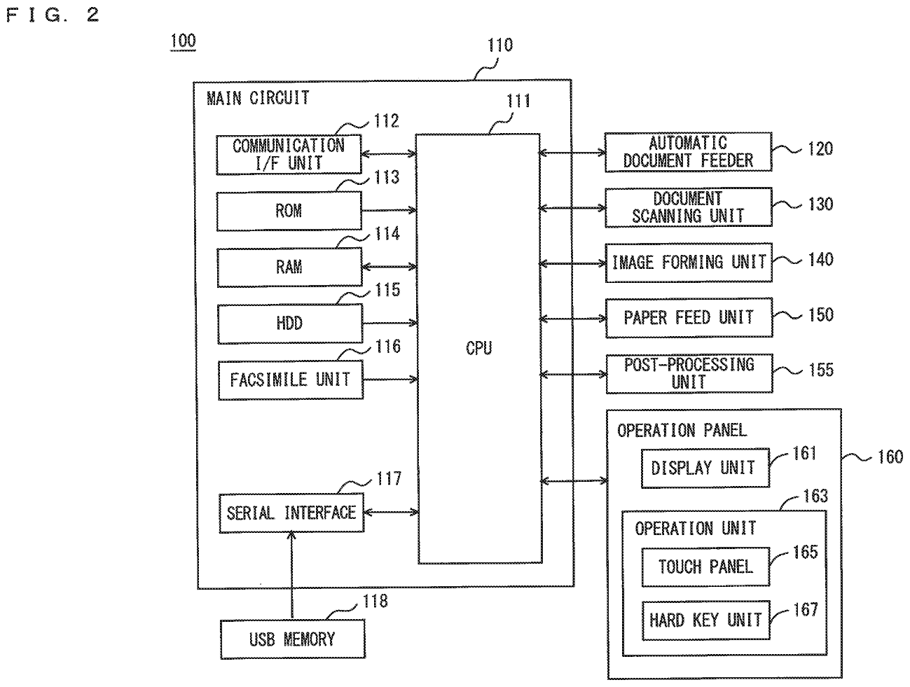

FIG. 1 is a perspective view showing the appearance of an MFP in one embodiment of the present invention. FIG. 2 is a block diagram showing the outline of the hardware configuration of the MFP. Referring to FIGS. 1 and 2, the MFP 100 includes a main circuit 110, a document scanning unit 130 for scanning a document, an automatic document feeder 120 for conveying a document to the document scanning unit 130, an image forming unit 140 for forming an image on a paper (a sheet of paper) based on image data that is output by the document scanning unit 130 that has scanned a document, a paper feed unit 150 for supplying a paper to the image forming unit 140, a post-processing unit 155 for processing a paper on which an image is formed and an operation panel 160 serving as a user interface.

The post-processing unit 155 performs a sorting process of sorting and discharging one or more papers on which images have been formed by the image forming unit 140, a punching process of punching the papers and a stapling process of stapling the papers.

The main circuit 110 includes a CPU 111, a Communication Interface (I/F) unit 112, a ROM 113, a RAM 114, a Hard Disk Drive (HDD) 115 as a mass storage, a facsimile unit 116, and a serial interface 117 on which a USB memory 118 is mounted. The CPU 111 is connected to the automatic document feeder 120, the document scanning unit 130, the image forming unit 140, the paper feed unit 150, the post-processing unit 155 and the operation panel 160, and controls the entire MFP 100.

The ROM 113 stores a program executed by the CPU 111 or data necessary for execution of the program. The RAM 114 is used as a work area when the CPU 111 executes a program. Further, the RAM 114 temporarily stores image data successively transmitted from the document scanning unit 130.

The communication I/F unit 112 is an interface for connecting the MFP 100 to a network. The CPU 111 communicates with PCs 200, 200A to 200C via the communication I/F unit 112, and transmits data to and receive data from the PCs 200, 200A to 200C. Further, the communication I/F unit 112 can communicate with a computer connected to the Internet via the network.

The facsimile unit 116 is connected to the Public Switched Telephone Networks (PSTN) and transmits facsimile data to or receives facsimile data from the PSTN. The facsimile unit 116 stores the received facsimile data in the HDD 115 or outputs the data to the image forming unit 140. The image forming unit 140 prints the facsimile data received by the facsimile unit 116 on a paper. Further, the facsimile unit 116 converts the data stored in the HDD 115 into facsimile data, and transmits the facsimile data to a facsimile machine connected to the PSTN.

The serial interface 117 is an interface for performing serial communication with an external device. Here, the serial communication supports the USB (Universal Serial Bus) standard. An external device that is communicable using the USB standard can be connected to the serial interface 117. The CPU 111 can access the external device through the serial interface 117. The external device includes an external storage device such as a USB memory 118 or a CD drive. Here, the external device is the USB memory 118 by way of example. The USB memory 118 includes a semi-conductor memory such as an EPROM (Erasable Programmable ROM) and a serial communication circuit. The CPU 111 loads the program recorded in the USB memory 118 attached to the serial interface 117 into the RAM 114 for execution.

It is noted that the medium for storing the program executed by the CPU 111 is not restricted to the USB memory 118. It may be an optical disc (a CD-ROM (Compact Disk ROM), a MO (Magnetic Optical Disc), a MD (a mini disc and a DVD (Digital Versatile Disc)), an optical card or a mask ROM.

Further, the program executed by the CPU 111 is not restricted to the program recorded in the USB memory 118. The CPU 111 may load the program, stored in the HDD 115, into the RAM 114 for execution. In this case, another computer connected to the network may rewrite the program stored in the HDD 115 of the MFP 100, or may additionally write a new program therein. Further, the MFP 100 may download a program from another computer connected to the network, and store the program in the HDD 115. The program referred to here includes not only a program directly executable by the CPU 111 but also a source program, a compressed program, an encrypted program or the like.

The operation panel 160 is provided on the upper surface of the MFP 100 and includes a display unit 161 and an operation unit 163. The display unit 161 is a Liquid Crystal Display device (LCD) or an organic EL (Electroluminescence) display and displays instruction menus to users, information about the acquired image data, and other information. The operation unit 163 includes a touch panel 165 and a hard key unit 167. The touch panel 165 is superimposed on the upper surface or the lower surface of the display unit 161. The hard key unit 167 includes a plurality of hard keys. The hard keys are contact switches, for example. The touch panel 165 detects a position designated by a user on the display surface of the display unit 161.

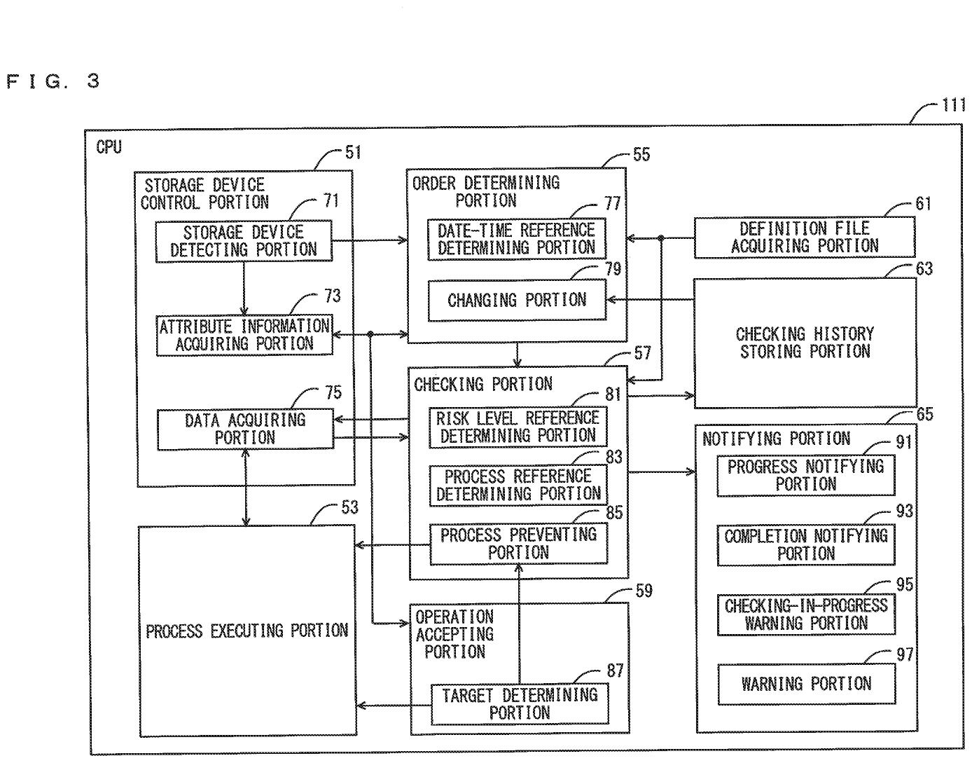

FIG. 3 is a block diagram showing one example of the functions of the CPU included in the MFP. The functions shown in FIG. 3 are formed in the CPU 111 when the CPU 111 included in the MFP 100 executes a virus checking program stored in the ROM 113, the HDD 115 or the USB memory 118. Referring to FIG. 3, the CPU 111 includes a storage device control portion 51, a process executing portion 53, an order determining portion 55, a checking portion 57, an operation accepting portion 59, a definition file acquiring portion 61, a checking history storing portion 63 and a notifying portion 65.

The definition file acquiring portion 61 acquires a definition file from a predetermined server. The definition file is the file recording the features of computer viruses and is used in order for the checking portion 57 to detect a computer virus in a data piece. While not restricted, the point in time at which the definition file acquiring portion 61 acquires the definition file is a predetermined certain point in time. Certain points in time may be set at certain intervals, or may be the points in time designated by the user. Further, the definition file acquiring portion 61 may acquire the definition file in response to the update of the definition file in a server. For example, the certain point in time may be 12:00 every day. The definition file acquiring portion 61 outputs the definition file to the checking portion 57 in response to acquisition of the definition file.

The definition file acquiring portion 61 acquires the risk level information together with the definition file from the server. The risk level information defines the relationship between the attribute and the risk level of each data piece. The attribute of a data piece is the file format of the data piece. The file format is the format of a data piece. The risk level represents the magnitude of probability of a data piece causing the MFP 100 to be infected with a computer virus. The more likely a computer virus is included in a data piece, the higher the risk level is. The definition file acquiring portion 61 outputs the risk level information to the order determining portion 55.

The storage device control portion 51 communicates with an external device attached to the serial interface 117 and controls the external device. The storage device control portion 51 includes a storage device detecting portion 71, an attribute information acquiring portion 73 and a data acquiring portion 75. The storage device detecting portion 71 controls the serial interface 117 and detects the external device connected to the serial interface 117. Specifically, when the USB memory 118 is attached to the serial interface 117, the storage device detecting portion 71 detects the USB memory 118. In response to detection of the USB memory 118, the storage device detecting portion 71 outputs an attachment signal to the attribute information acquiring portion 73 and an order determining portion 55.

In response to reception of the attachment signal from the storage device detecting portion 71, the attribute information acquiring portion 73 acquires the attribute information of each of one or more data pieces stored in the USB memory 118. The attribute of a data piece is determined by an extension of its file name. The attribute information acquiring portion 73 acquires the file name of each of the one or more data pieces stored in the USB memory 118. Because a computer virus is not present in the file name of a data piece, even when the file name of a data piece is read from the USB memory 118, a computer virus is not read from the USB memory 118. The attribute information acquiring portion 73 outputs the file name of each of the one or more data pieces to the operation accepting portion 59 and the order determining portion 55.

In response to input of a read instruction from a checking portion 57 or a process executing portion 53, described below, the data acquiring portion 75 reads out the data piece having the file name specified by the read instruction from the USB memory 118, and outputs the read data to the one, which has output the read instruction, of the checking portion 57 and the process executing portion 53.

The operation accepting portion 59 controls the operation panel 160 and accepts a user's operation of inputting in the operation unit 163. For example, an operation screen is displayed in the display unit 161, and a user's operation of inputting in the operation unit 163 according to the operation screen is accepted. The operation screen includes a setting screen for setting an operation condition for execution of a process by the process executing portion 53. The operation condition includes a condition defining the process executed by the process executing portion 53 and a condition defining the content of the process executed by the process executing portion 53. The operation accepting portion 59 outputs a user's operation of inputting in the operation unit 163 to the process executing portion 53.

The setting screen includes a process selection screen for selection of a process to be executed by the MFP 100 from among the processes executable by the MFP 100. In the case where the user inputs an operation in the operation unit 163 according to the process selection screen, the operation accepting portion 59 accepts a process selecting operation of selecting a process.

Further, the operation screen includes a setting screen for setting a setting value for execution of a process. For example, the setting values in regards to the image formation process include a color-mode setting value and a number setting value. The color-mode setting value defines whether a monochrome image or a color image is to be formed. The number setting value defines the number of times images are formed. In the case where the user inputs an operation in the operation unit 163 according to the setting screen, the operation accepting portion 59 accepts a setting operation of setting a setting value.

The operation accepting portion 59 includes a target determining portion 87. The target determining portion 87 determines a data piece that is to be processed by the process executing portion 53 as a target data piece. The operation screen includes a data selection screen for selection of a data piece to be processed. The data selection screen is the screen for accepting a setting value specifying one of the plurality of data pieces stored in the HDD 115 or the USB memory 118 attached to the serial interface 117. Here, the setting value specifying one of the plurality of data pieces stored in the USB memory 118 is accepted by way of example. The target determining portion 87 produces a data selection screen in which the file name of each of the one or more data pieces received from the attribute information acquiring portion 73 is selectable and displays the data selection screen in the display unit 161. In the case where the user inputs an operation in the operation unit 163 according to the data selection screen, the target determining portion 87 accepts a data designating operation of selecting a data piece. The target determining portion 87 outputs the data identification information for identifying the data piece specified by the data designating operation to the process executing portion 53 and the checking portion 57.

The process executing portion 53 controls the hardware resources, sets the operation condition according to the operation accepted by the operation accepting portion 59 and executes the process according to the operation condition. Specifically, the hardware resources include the document scanning unit 130, the automatic document feeder 120, the image forming unit 140, the paper feed unit 150, the operation panel 160, the HDD 115, the communication I/F unit 112, the facsimile unit 116 and the serial interface 117. Although the processes to be executed by the process executing portion 53 are not restricted, the processes include a document scanning process, an image formation process, a data transmission reception process, a facsimile transmission reception process, a data management process and an external service execution process. The document scanning process is the process of outputting image data that is obtained when a document is scanned by the document scanning unit 130. The image formation process is the process of causing the image forming unit 140 to form an image of a data piece on a paper supplied from the paper feed unit 150. The data transmission reception process is the process of receiving a data piece from the computer connected to the LAN 3 through the communication I/F unit 112 or the process of transmitting the data piece stored in the HDD 115 or the USB memory 118 to the computer connected to the LAN 3 through the communication I/F unit 112. The facsimile transmission reception process is the process of causing the facsimile unit 116 to transmit an image of facsimile data, or the process of receiving an image of the facsimile data from outside.

The data management processes are the process of storing a data piece in the HDD 115 or the USB memory 118 attached to the serial interface 117, the process of changing or deleting a data piece stored in the HDD 115 or the USB memory 118 and the process of selecting one or more data pieces from the data pieces stored in the HDD 115 or the USB memory 118 as a data piece to be processed. The process of changing a data piece includes an image process of editing a data piece and an image process of changing a format. The external service execution process is the process of requesting an external computer to execute a certain process. The certain process is the process executed by the external computer. Although not being restricted, the certain process includes the process of character recognition of an image data piece, the process of translating the character information into different languages and the process of converting the format of a data piece, for example. The processes executable by the process executing portion 53 are not restricted to the document scanning process, the image formation process, the data transmission reception process, the facsimile transmission reception process, the data management process and the external service execution process, and may include other processes.

Further, the process executing portion 53 can execute a combination of two or more processes among the document scanning process, the image formation process, the data transmission reception process, the facsimile transmission reception process, the data management process and the external service execution process. For example, the process executing portion 53 executes a copy process, which is the combination of the document scanning process and the image formation process. Further, the process executing portion 53 executes a print process, which is the combination of a data reception process and the image formation process.

In response to reception of the attachment signal from the storage device detecting portion 71, the order determining portion 55 determines the order in which a virus checking process is executed on the one or more data pieces stored in the USB memory 118. The order determining portion 55 outputs the determined order with respect to the one or more data pieces stored in the USB memory 118 to the checking portion 57.

The order determining portion 55 determines a file name and an attribute of each of the one or more data pieces stored in the USB memory 118 based on the attribute information received from the attribute information acquiring portion 73. The order determining portion 55 determines the order, in which the one or more data pieces stored in the USB memory 118 are scanned, based on the risk level information received from the definition file acquiring portion 61. The order determining portion 55 determines the order such that the higher the risk level of the attribute of the data piece is, the earlier the data piece is scanned. Specifically, the order determining portion 55 reads out the file information of each of the one or more data pieces stored in the USB memory 118 and produces a scan table based on the file information. The file information includes at least the file name and the update date and point in time of a data piece. The order determining portion 55 determines the attribute of the data piece from the file name of the data piece. The order determining portion 55 changes the scan table by sorting the scan records in the order of descending risk levels associated with the attributes of the data pieces with reference to the risk level information.

The order determining portion 55 includes a date-time reference determining portion 77 and a changing portion 79. In the case where a plurality of data pieces having the same attribute are present among the one or more data pieces stored in the USB memory 118, the date-time reference determining portion 77 sorts the plurality of data pieces having the same attribute based on the update dates and points in time. The update dates and points in time may be read from the USB memory 118 together with the attribute information. The date-time reference determining portion 77 determines the scan order such that the later the update date and point in time of a data piece are, the earlier the data piece is scanned. The later the update date and point in time of a data piece are, the more likely the user may select the data piece as a data piece to be processed.

The changing portion 79 changes the scan order based on the history information of virus checking. The history information is stored in the HDD 115 by the checking history storing portion 63, described below. The history information includes the attributes of the data pieces in which computer viruses have been detected by the checking portion 57, described below. In the case where the history information is stored in the HDD 115, the changing portion 79 changes the scan table such that the data piece having the attribute included in the history information is scanned earlier than the data pieces having other attributes.

In the case where the history information is stored in the HDD 115, the changing portion 79 may change an attribute priority table instead of changing the scan order. The scan order is changed in such a manner that the data piece having an attribute included in the history information is given a higher priority than data pieces having other attributes. In the case where a plurality of different attributes are present in the history information, the later the date and point in time when an attribute is stored in the history information are, the higher the priority given to the attribute is. In the case where the attribute priority table is changed by the changing portion 79, the order determining portion 55 determines the order, in which the one or more data pieces are scanned, with reference to the changed attribute priority table.

The checking portion 57 checks whether a computer virus is present in the one or more data pieces stored in the USB memory 118. The checking portion 57 receives the order, in which the one or more data pieces stored in the USB memory 118 are respectively scanned, from the order determining portion 55. The checking portion 57 checks the one or more data pieces stored in the USB memory 118 according to the order received from the order determining portion 55.

The checking portion 57 includes a risk level reference determining portion 81, a process reference determining portion 83 and a process preventing portion 85. While checking whether a computer virus is present in a data piece having the attribute the risk level of which is equal to or higher than a certain threshold value TH1, the risk level reference determining portion 81 does not check whether a computer virus is present in a data piece having the attribute the risk level of which is lower than the certain threshold value TH1. For example, a computer virus is not embedded in a data piece having the attribute which is a text. It is preferable that the attribute the risk level of which is lower than the certain threshold value TH1 is the attribute of a data piece in which a computer virus is not embedded.

In the case where a process to be executed by the process executing portion 53 on a target data piece received from the target determining portion 87 is a predetermined process, the process reference determining portion 83 does not check whether a computer virus is present in the target data piece. The predetermined process is the process of storing the target data piece in the HDD 115. The MFP 100 does not become infected with a computer virus only by storing the target data piece in the HDD 115. The process reference determining portion 83 may check whether a computer virus is present in the target data piece after the target data piece received from the target determining portion 87 is stored in the HDD 115.

The process preventing portion 85 prevents the process executing portion 53 from executing a process on the target data piece until the checking portion 57 completes checking whether a computer virus is present in the target data piece received from the target determining portion 87. The process preventing portion 85 outputs a prevention signal to the process executing portion 53 until the checking portion 57 completes checking whether a computer virus is present in the target data piece. In the case where the checking portion 57 completes checking whether a computer virus is present in the target data piece, and determines that a computer virus is not present, the process preventing portion 85 stops outputting the prevention signal to the process executing portion 53 and outputs a permission signal.

The checking portion 57 does not check whether a computer virus is present from the time when the process preventing portion 85 outputs the permission signal to the process executing portion 53 until the process executing portion 53 finishes executing the process. In response to completion of the process executed on the target data piece by the process executing portion 53, the checking portion 57 restarts checking. Specifically, the checking portion 57 checks whether a computer virus is present in one or more data pieces, which have not been checked, among the one or more data pieces stored in the USB memory 118.

In the case where it is determined that a computer virus is present as a result of checking performed by the checking portion 57, the checking history storing portion 63 stores the history information in the HDD 115. The history information includes at least the attribute of the data piece, which has been determined to include a computer virus, and the date and point in time when the data piece is checked.

The notifying portion 65 includes a progress notifying portion 91, a completion notifying portion 93, a checking-in-progress warning portion 95 and a warning portion 97. The progress notifying portion 91 provides notification of the progress while the checking portion 57 is executing the virus checking process on the one or more data pieces stored in the USB memory 118. For example, the notifying portion 65 displays the message indicating that a data piece is being checked for presence of a computer virus, and the file name of the data piece being checked in the display unit 161.

In response to completion of checking of the one or more data pieces stored in the USB memory 118 performed by the checking portion 57, the completion notifying portion 93 provides notification of completion of the virus checking process. For example, the completion notifying portion 93 displays the message indicating the completion of checking for presence of a computer virus in the display unit 161.

In response to detection of detachment of the USB memory 118 from the serial interface 117 by the storage device detecting portion 71 before the checking portion 57 completes checking the one or more data pieces stored in the USB memory 118, the warning portion 97 provides a warning. For example, the warning portion 97 displays the message indicating that checking for presence of a computer virus is not completed in the display unit 161. However, the warning portion 97 provides a warning in the case where a data piece having the attribute the risk level of which is equal to or higher than a threshold value TH3 is present among the one or more data pieces, which have not been checked and are among the one or more data pieces stored in the USB memory 118, when the detachment of the USB memory 118 from the serial interface 117 is detected by the storage device detecting portion 71. In the case where the risk level is lower than the threshold value TH3, the MFP 100 may not become infected with a computer virus. The threshold value TH3 is larger than the threshold value TH1 and equal to or smaller than a threshold value TH2.

In the case where a data piece having the attribute the risk level of which is equal to or higher than the threshold value TH2 is present among the one or more data pieces, which have not been checked and are among the one or more data pieces stored in the USB memory 118, while the checking portion 57 is checking the one or more data pieces stored in the USB memory 118, the checking-in-progress warning portion 95 provides notification of prohibition of an operation of detaching the USB memory 118 from the serial interface 117. For example, the checking-in-progress warning portion 95 displays the message indicating the prohibition of the operation of detaching the USB memory 118 from the serial interface 117.

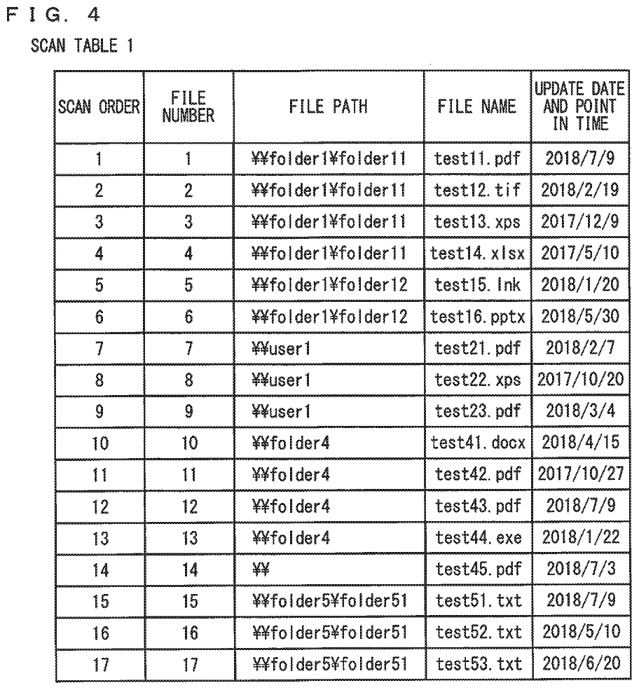

FIG. 4 is a first diagram showing one example of the scan table. The scan table shown in FIG. 4 shows one example of the scan table produced at the point in time at which 17 data pieces stored in the USB memory 118 are read. Referring to FIG. 4, the scan table includes data records respectively corresponding to the plurality of data pieces stored in the USB memory 118. Each data record includes a “scan order” field, a “file number” field, a “file path” field, a “file name” field and an “update date and point in time” field. In the “scan order” field, the order in which the virus checking process of checking presence of a computer virus is executed is set. In the “file number” field, the numbers assigned to data pieces is set. Here, in the “file number” field, the order in which the data pieces are read from the USB memory 118 is set. In the “file path” field, the information indicating the location of folders, where the data pieces are stored, in the USB memory 118 is set. In the “file name” field, the names given to the data pieces are set. The extensions included in the file names indicate the attributes of the files. In the “update date and point in time” field, the dates and points in time when the data pieces are last updated are set.

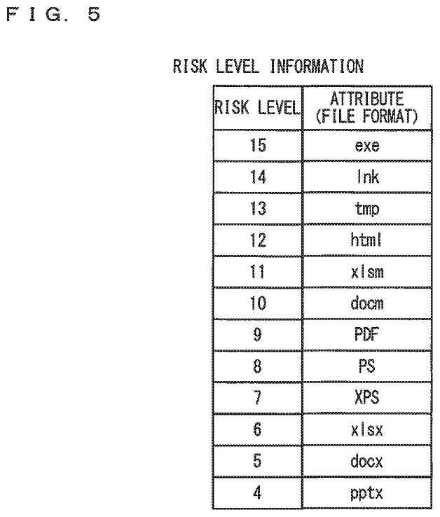

FIG. 5 is a diagram showing one example of risk level information. The risk level information includes a risk level record that associates each attribute with the risk level. Referring to FIG. 5, the risk level record includes a “risk level” field and an “attribute” field. In the “attribute” field, the attributes of data pieces are set. The attribute is a file format. In the “risk level” field, the risk levels are set. The larger the number is, the higher the risk level is. The data piece having an attribute the risk level of which is high is scanned earlier, whereby the virus checking process can be executed in such a manner that the data piece having an attribute the risk level of which is high is given a higher priority than the data piece having an attribute the risk levels of which is low.

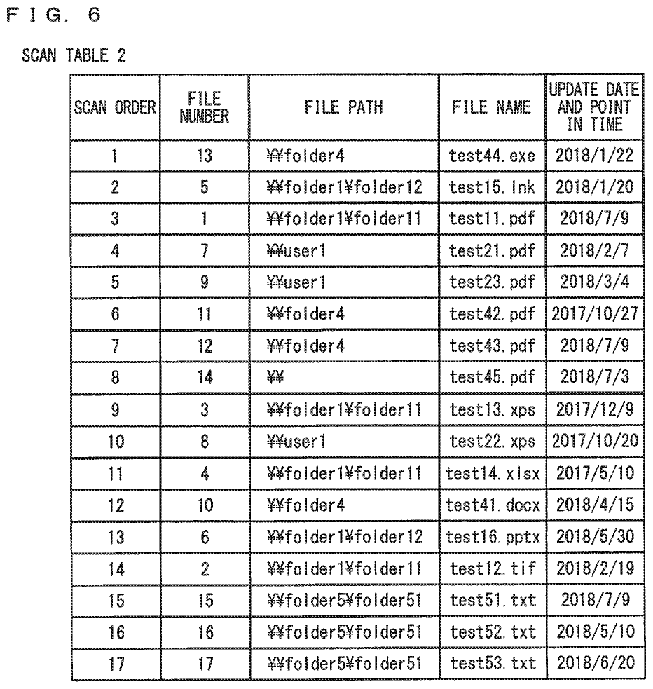

FIG. 6 is a second diagram showing one example of the scan table. The scan table shown in FIG. 6 shows the scan table produced by sorting the scan records in the scan table shown in FIG. 4 in the order of descending risk levels based on the risk level information. A data piece having the attribute “tif” or “txt” is not included in the risk level information. This indicates that there is no possibility for a computer virus to be embedded in these files.

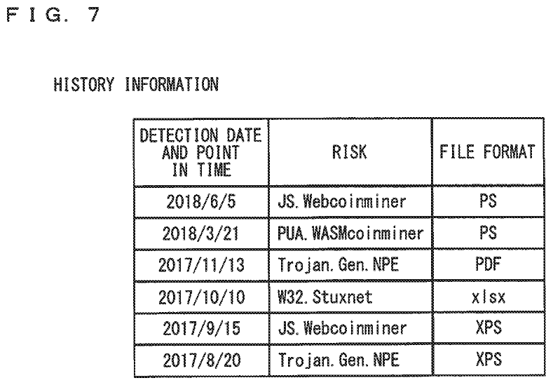

FIG. 7 is a diagram showing one example of the history information. The history information includes history records. Each history record is produced each time the virus checking process is executed and a computer virus is detected. The history record includes a “detection date and point in time” field, a “risk” field and a “file format” field. In the “detection date and point in time” field, the dates and points in time when computer viruses are detected are set. In the “risk” field, the information specifying computer viruses is set. In the “format” field, the attributes of the data pieces in which computer viruses are detected are set. The history information shows that computer viruses were detected in the data pieces having the attributes “PS,” “PDF,” “xlsx” and “XPS.”

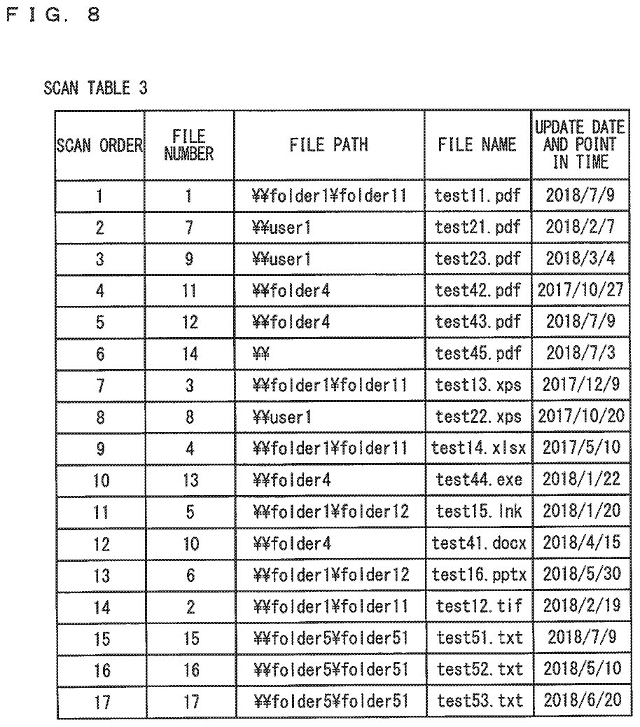

FIG. 8 is a third diagram showing one example of the scan table. The scan table shown in FIG. 8 is the scan table produced by sorting the scan records in the scan table shown in FIG. 6 such that the data pieces having the attributes present in the history information are scanned earlier. Since the history information indicates that the data pieces having the attributes defined in the history information have been input to the MFP 100 in the past, the user is highly likely to use the data pieces having the same attributes and the data pieces having the same attributes are highly likely to be stored in the USB memory 118. Therefore, it is possible to increase the probability of the target data piece, which is designated by the user as the data piece to be processed, being scanned earlier by sorting the scan records in the scan table based on the history information.

The history information includes a plurality of history records, and the number of attributes of the data pieces in which computer viruses have been detected in the past is four. In this case, the file format the detection date and point in time of which are more recent is given a higher priority than the file format the detection data and time of which are older. Specifically, in the scan table shown in FIG. 6, a scan record the attribute of which is “PS” is not present. Thus, the scan records included in the scan table shown in FIG. 6 are sorted in the order of “PDF”, “XPS” and “xlsx.”

The data piece the detection date and point in time of which are more recent is more likely to be used by the user than the data piece the detection date and point in time of which are older, and is more likely to be stored in the USB memory 118 than the data piece the detection date and point in time of which are older. Therefore, it is possible to increase the probability of the target data piece, which is designated by the user as the data piece to be processed, being scanned earlier by sorting the scan records in the scan table based on the detection dates and points in time.

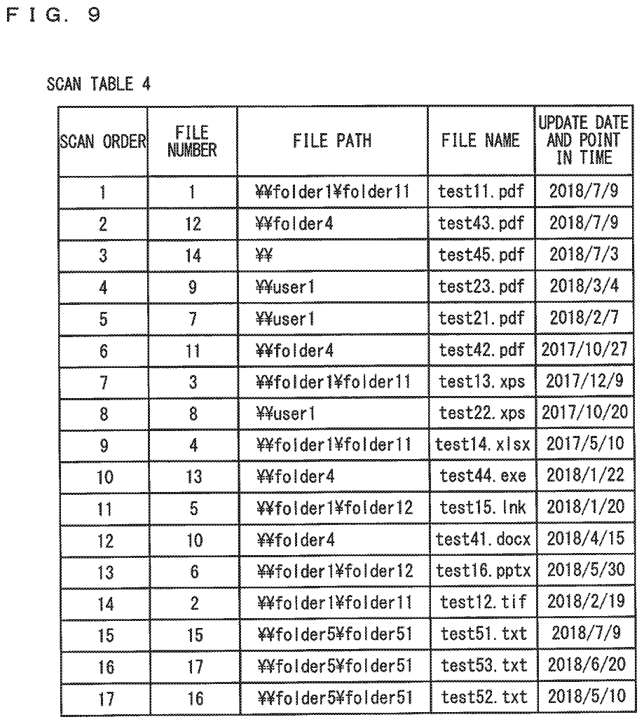

FIG. 9 is a fourth diagram showing one example of the scan table. The scan table shown in FIG. 9 is the scan table produced by sorting the scan records of the plurality of data pieces having the same attribute based on the update dates and points in time. For example, there are six data pieces having the file format “PDF” and their file numbers are 1, 7, 9, 11, 12 and 14. The scan records of the data pieces having the file numbers 1, 7, 9, 11, 12 and 14 are sorted such that the scan records the update dates and points in time of which are more recent are scanned earlier than the scan records the update dates and points in time of which are older. As a result, the data pieces are scanned in the order of the file numbers 1, 12, 14, 9, 7 and 11. The data piece the update date and point in time of which are more recent is more likely to be used by the user than the data piece the update date and point in time of which are older. Therefore, it is possible to increase the probability of the target data piece, which is designated by the user as the data to be processed, being scanned earlier by sorting the plurality of scan records respectively corresponding to the plurality of data pieces having the same attribute based on the update dates and points in time.

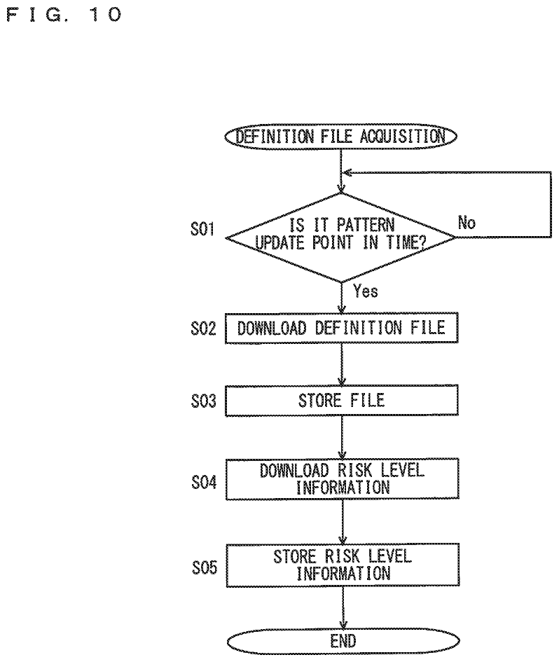

FIG. 10 is a flow chart showing one example of a flow of a definition file acquisition process. The definition file acquisition process is the process executed by the CPU 111 when the CPU 111 included in the MFP 100 executes a data sharing program stored in the ROM 113, the HDD 115 or the USB memory 118.

Referring to FIG. 10, the CPU 111 determines whether the current date and point in time are a pattern update point in time (step S01). The CPU 111 waits until the current date and point in time reach the pattern update point in time (NO in the step S01). When the current date and point in time reach the pattern update point in time, the process proceeds to the step S02. In the step S02, a definition file is downloaded from the server, and the process proceeds to the step S03. In the step S03, the definition file is stored in the HDD 115, and the process proceeds to the step S04. In the step S04, the risk level information is downloaded from the server, and the process proceeds to the step S05. In the step S05, the risk level information is stored in the HDD 115, and the process ends.

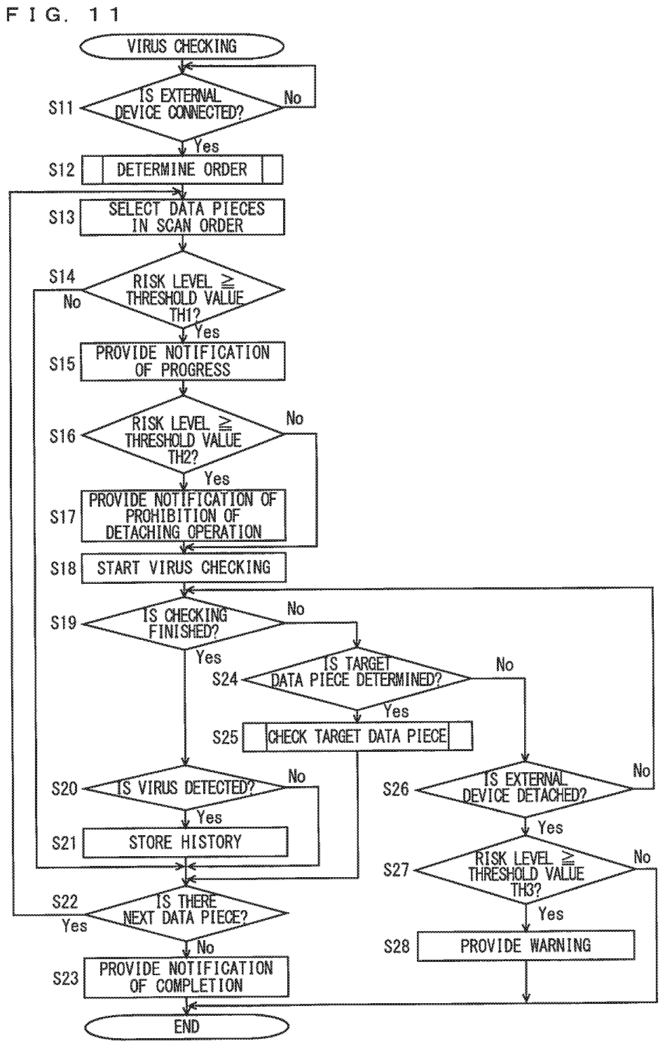

FIG. 11 is a flow chart showing one example of a flow of the virus checking process. The virus checking process is executed by the CPU 111 when the CPU 111 included in the MFP 100 executes the virus checking program stored in the ROM 113, the HDD 115 or the USB memory 118. Referring to FIG. 11, the CPU 111 determines whether an external device is connected to the serial interface 117. The CPU 111 waits until the external device is connected (NO in the step S11). When the external device is connected, the process proceeds to the step S12. Here, the USB memory 118 is connected to the serial interface 117 as the external device by way of example.

In the step S12, an order determination process is executed. The order determination process, which will be described below in detail, is the process of determining the scan order in which the virus checking is performed on the plurality of data pieces stored in the USB memory 118.

In the step S13, the data pieces that are to be checked for computer viruses are selected in the scan order, and the process proceeds to the step S14. In the step S14, the CPU 111 determines whether the risk level corresponding to the attribute of the data piece to be checked is equal to or higher than the threshold value TH1. If the risk level is equal to or higher than the threshold value TH1, the process proceeds to the step S15. If not, the process proceeds to the step S22. The risk level lower than the threshold value TH1 is assigned to the attribute of the data piece that has no possibility of including a computer virus.

In the step S15, the CPU 111 provides notification of a data piece being checked for a computer virus, and the process proceeds to the step S16. For example, the message indicating that the data piece is being checked, and the file name of the data piece to be checked are displayed in the display unit 161.

In the step S16, the CPU 111 determines whether the risk level is equal to or higher than the threshold value TH2. The threshold value TH2 is larger than the threshold value TH1 and is a predetermined value. If the risk level is equal to or higher than the threshold value TH2, the process proceeds to the step S17. If not, the process proceeds to the step S18. In the step S17, the CPU 111 provides notification of prohibition of an operation of detaching the USB memory 118, and the process proceeds to the step S18. For example, the CPU 111 displays the message indicating the prohibition of the operation of detaching the USB memory 118 from the serial interface 117 in the display unit 161.

In the step S18, the CPU 111 starts performing virus checking on the data piece that is selected in the step S13 as the data piece to be checked. In the next step S19, determination is made whether the CPU 111 has finished virus checking. If the CPU 111 has finished performing virus checking, the process proceeds to the step S20. If not, the process proceeds to the step S24. In the step S20, the CPU 111 determines whether a computer virus has been detected. If a computer virus is detected, the process proceeds to the step S21. If not, the process proceeds to the step S22. In the step S21, the history information showing the virus checking history is stored in the HDD 115, and the process proceeds to the step S22. The history information includes the dates and points in time when the computer viruses are detected, the information for specifying the computer viruses, and the attributes of the data pieces in which the computer viruses are detected.

In the step S22, the CPU 111 determines whether the data piece to be checked is present. Whether the data piece that is not selected in the step S13 as the data piece to be checked is present among the data pieces stored in the USB memory 118 is determined. If such a data piece is present, the process returns to the step S13. If not, the process proceeds to the step S23. In the step S23, the CPU 111 provides notification of the completion of virus checking, and the process ends. For example, the CPU 111 displays the message indicating the completion of checking for a computer virus in the display unit 161.

In the step S24, the CPU 111 determines whether the target data piece has been determined. If the user who operates the MFP 100 selects the data piece to be processed from among the data pieces stored in the USB memory 118 in order to cause the MFP 100 to execute a process, the selected data piece is determined as a target data piece. If the target data piece is determined, the process proceeds to the step S25. If not, the process proceeds to the step S26. In the step S25, a target data checking process is executed, and the process proceeds to the step S22. The target data checking process, which will be described below in detail, is the process of checking presence of a computer virus in such a manner that the target data piece is given higher priority than the other data pieces stored in the USB memory 118.

In the step S26, the CPU 111 determines whether an external device is detached from the serial interface 117. If the external device has been detached, the process proceeds to the step S27. If not, the process returns to the step S19. In the step S27, the CPU 111 determines whether the risk level of the data piece to be checked is equal to or higher than the threshold value TH3. The threshold value TH3 is larger than the threshold value TH1 and equal to or smaller than the threshold value TH2. If the risk level is equal to or higher than the threshold value TH3, the process proceeds to the step S28. If not, the process ends.

In the step S28, the CPU 111 warns the user, and the process ends. For example, the message indicating that checking for computer viruses is not completed is displayed in the display unit 161.

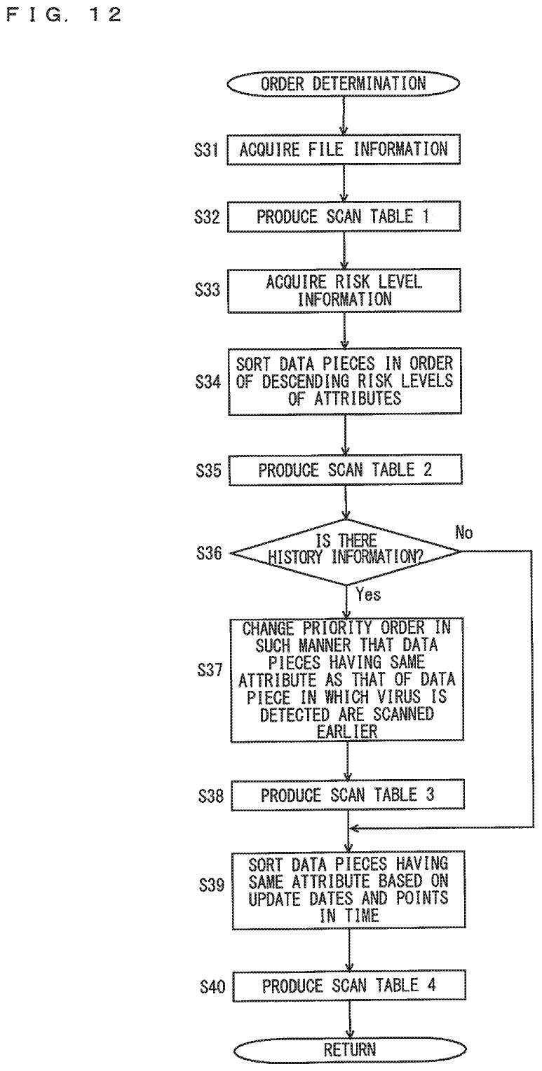

FIG. 12 is a flow chart showing one example of a flow of the order determination process. The order determination process is the process executed in the step S12 of FIG. 11. Referring to FIG. 12, the CPU 111 acquires the file information (step S31). Specifically, the CPU 111 reads out the file information of the one or more data pieces stored in the USB memory 118. The file information includes at least the file name and the update date and point in time of each data piece. In the next step S32, the scan table 1 is produced based on the file information. The scan table 1 is the table in which scan records including the file numbers, the file paths, the file names and the update dates and points in time of data pieces are arranged.

In the next step S33, the risk level information is acquired. The risk level information stored in the HDD 115 is downloaded from the server for acquisition. In the next step S34, the data pieces are sorted in the order of descending risk levels. Then, the scan table 2 is produced (step S35). The CPU 111 produces the scan table 2 in which the scan records included in the scan table 1 are sorted in the order of descending risk levels associated with the attributes of the data pieces.

In the next step S36, the CPU 111 determines whether the history information is stored. If the history information is stored in the HDD 115, the process proceeds to the step S37. If not, the process proceeds to the step S39. In the step S37, the scan order is changed such that the data piece, having the attribute that is defined by the history information as the attribute of the data piece in which a computer virus has been detected, is scanned earlier. Then, a scan table 3 is produced (step S38). The CPU 111 produces the scan table 3 in which the scan records included in the scan table 2 are sorted in such a manner that the data pieces, having the attributes included in the history information, are scanned earlier than the data pieces having other attributes.

In the next step S39, the CPU 111 sorts the data pieces having the same attribute based on the update dates and points in time. Then, a scan table 4 is produced (step S40), and the process returns to the virus checking process. The CPU 111 produces the scan table 4 in which the scan records included in the scan table 3 are sorted in such a manner that the data pieces having the attributes included in the history information are scanned earlier than the data pieces of other attributes.

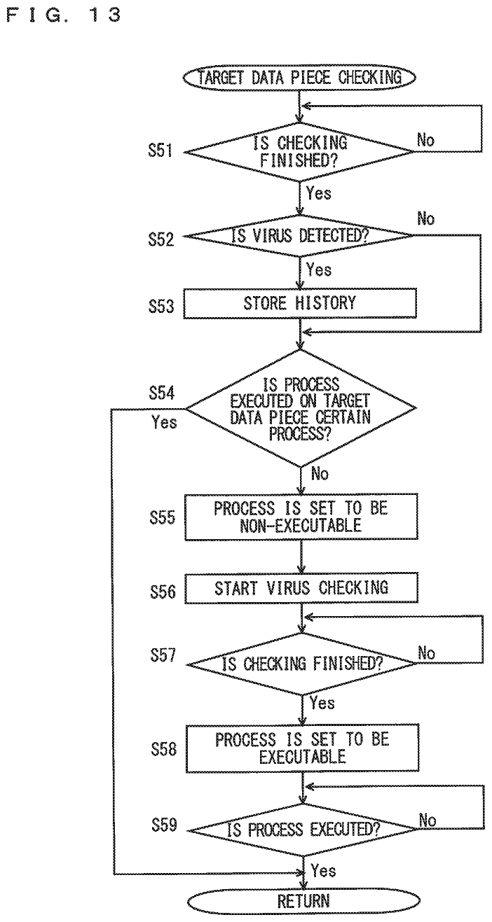

FIG. 13 is a flow chart showing one example of a flow of the target data checking process. The target data checking process is the process executed in the step S25 of FIG. 10. Before the target data checking process is executed, the CPU 111 determines a target data piece and starts checking for a computer virus in any one of the plurality of data pieces stored in the USB memory 118.

Referring to FIG. 13, the CPU 111 determines whether virus checking that has been in progress has ended. The process waits until the virus checking is finished (NO in the step S51). When the virus checking is finished (YES in the step S51), the process proceeds to the step S52. In the step S52, whether a computer virus is detected is determined. If a computer virus is detected, the process proceeds to the step S53. If not, the process proceeds to the step S54. In the step S53, the history information showing the virus checking history is stored in the HDD 115, and the process proceeds to the step S54.

In the step S54, the CPU 111 determines whether the process that is set to be executed on the target data piece is a certain process. The certain process is the process of storing a data piece in the HDD 115. If the process to be executed on the target data piece is the certain process, the process proceeds to the step S59. If not, the process proceeds to the step S55. The certain process is the process that does not cause the MFP 100 to be infected with a computer virus when executed on the target data piece.

In the step S55, the process is set to be non-executable on the target data piece, and the process proceeds to the step S56. In the step S56, the CPU 111 starts performing the virus checking on the target data piece, and the process proceeds to the step S57. In the step S57, the CPU 111 determines whether the virus checking has finished. The process waits until the virus checking is finished (NO in the step S57). When the virus checking is finished (YES in the step S57), the process proceeds to the step S58.

In the step S58, the process is set to be executable on the target data piece, and the process proceeds to the step S59. In the step S59, the CPU 111 determines whether the process has been executed on the target data piece. The process waits until the process is executed on the target data piece (NO in the step S59). If the process is executed on the target data piece (YES in the step S59), the process returns to the virus checking process. Since virus checking is not performed on the other data pieces while the process is being executed on the target data piece, a load applied to the CPU 111 can be as small as possible, and the period of time during which the process is executed on the target data piece can be prevented from being lengthened.

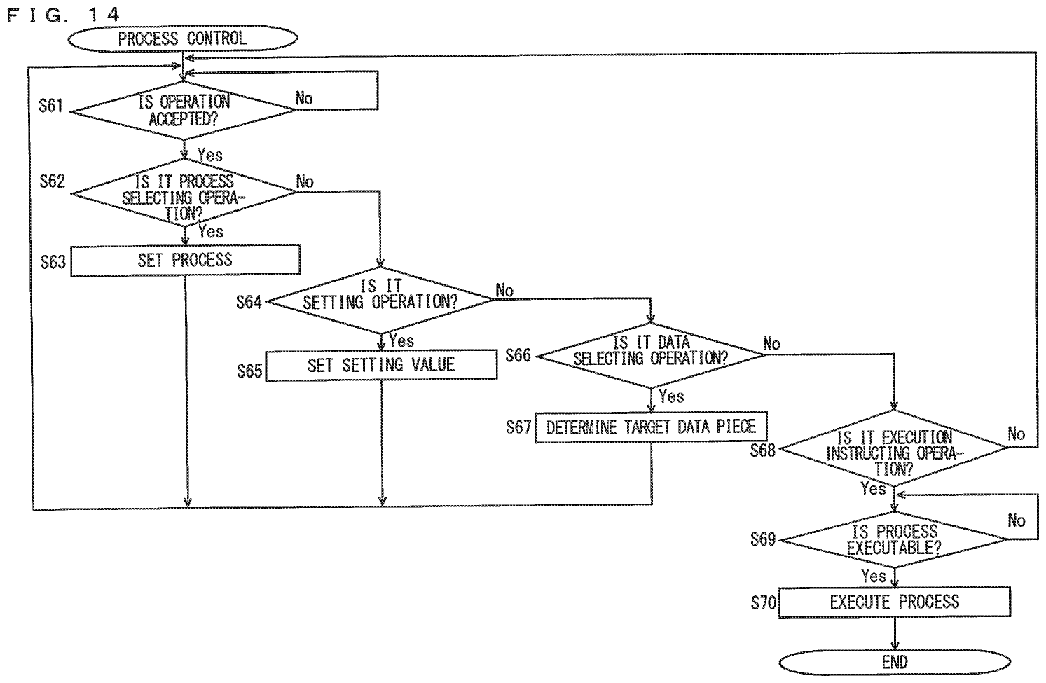

FIG. 14 is a flow chart showing one example of a flow of a process control process. The process control process is the process executed by the CPU 111 when the CPU 111 included in the MFP 100 executes a control program stored in the ROM 113, the HDD 115 or the USB memory 118. Referring to FIG. 14, the CPU 111 determines whether an operation has been accepted (step S61). The process waits until the operation unit 163 accepts an operation input by the user (NO in the step S61). If the operation is accepted, the process proceeds to the step S62.

In the step S62, the CPU 111 determines whether the operation input by the user is a process selecting operation of selecting a process (step S61). If the operation is the process selecting operation, the process proceeds to the step S63. If not, the process proceeds to the step S64. In the step S63, the process specified by the process selecting operation is set to be executable, and the process returns to the step S61.

In the step S64, the CPU 111 determines whether the operation input by the user is an operation of setting a setting value. If the operation is the setting operation, the process proceeds to the step S65. If not, the process proceeds to the step S66. In the step S65, the setting value specified by the setting operation is set in the CPU 111, and the process returns to the step S61.

In the step S66, the CPU 111 determines whether the operation input by the user is a data designating operation of designating a data piece. If the operation is the data designating operation, the process proceeds to the step S67. If not, the process proceeds to the step S68. In the step S67, the data piece specified by the data designating operation is determined as a target data piece, and the process returns to the step S61.

In the step S68, the CPU 111 determines whether the operation input by the user is an execution instructing operation of providing an instruction for executing the process. If the operation is the execution instructing operation, the process proceeds to the step S69. If not, the process returns to the step S61. In the step S69, the CPU 111 determines whether the process is executable. If the process is set to be non-executable on the target data piece, the process waits (NO in the step S69). If the process is set to be executable on the target data piece (YES in the step S69), the process proceeds to the step S70.

In the step S70, the process is executed according to an operation condition, and the process ends. Specifically, the CPU 111 executes the process set in the step S63 on the target data piece determined in the step S67 according to the setting value set in the step S65.

As described above, the MFP 100 in the present embodiment functions as an image forming apparatus, and checks presence of a computer virus in the target data piece in preference to the other data pieces in response to determination of the target data piece to be processed while checking the presence of a computer virus in the plurality of data pieces stored in the USB memory 118 that functions as an external storage device. Therefore, the process is executed on the target data piece before all of the plurality of data pieces stored in the USB memory 118 are checked, so that a user's waiting period of time can be shortened.

Further, in response to the end of checking for the presence of a computer virus in the target data piece, the MFP 100 restarts checking the data pieces, which have not been checked, among the plurality of data pieces stored in the USB memory 118. Thus, the MFP 100 can be prevented from being infected with a computer virus in the plurality of data pieces stored in the USB memory 118.

Further, because the MFP 100 determines the order, in which the plurality of data pieces stored in the USB memory 118 are checked, according to the risk levels defined with respect to the attributes of the data pieces, the data pieces having a high risk of including a computer virus can be checked earlier.

Further, because the MFP 100 downloads the risk level information that associates the risk levels with the attributes from the external server together with the definition files, the risk levels can be updated and the latest risk levels can be used.

Further, because the MFP 100 changes the order based on the attribute of the data piece in which a computer virus has been detected in the past, the data piece having the same attribute as the attribute of the data piece in which a computer virus has been detected in the past can be checked earlier than the other data pieces having other attributes.

Further, because the MFP 100 changes the order, in which the plurality of data pieces stored in the USB memory 118 and having the same risk level are scanned, based on the update dates and points in time, the data pieces the update dates and points in time of which are more recent can be checked earlier than the data pieces the update dates and points in time of which are older. The more recent the update dates and points in time of a data piece are, the more likely the user selects the data piece as a data piece to be processed. Therefore, virus checking may be completable before the user designates the target data piece.

Further, because the MFP 100 provides a warning when the USB memory 118 is detached from the serial interface 117 before checking is completed, the user can be notified of non-completion of checking performed on all of the plurality of data pieces stored in the USB memory 118.

Further, the MFP 100 provides a warning in the case where the risk level of the data piece, that has not been checked for presence of a computer virus and is among the plurality of data pieces stored in the USB memory 118, is equal to or higher than a certain threshold value, and does not provide a warning in the case where the risk level of the data piece, that has not been checked for presence of a computer virus and is among the plurality of data pieces stored in the USB memory 118, is lower than the certain threshold value.

Further, because the MFP 100 does not check presence of a computer virus in the data piece having the attribute corresponding to a risk level indicating no risk of including a computer virus, the period of time required for checking can be shortened, and the waiting time for the user can be shortened.

Further, because the MFP 100 provides notification of prohibition of the operation of detaching the USB memory 118 while the risk level of the data piece, which has not been checked, among the plurality of data pieces stored in the USB memory 118 is equal to or higher than the certain threshold value, the USB memory 118 can be prevented from being detached by the user while the data piece, the risk level of which is equal to or higher than the certain threshold value, is being checked.

Further, in the case where the process of storing a target data piece in the HDD 115 is executed, the MFP 100 does not check presence of a computer virus in the target data piece. Thus, the process of preventing the MFP 100 from being infected with a computer virus can be made executable, and the waiting time for the user can be shortened. The target data piece may be checked after being stored in the HDD 115.

Further, after the process is executed on the target data piece, the MFP 100 checks a data piece which has not been checked for presence of a computer virus. Thus, the process executed on the target data piece and the checking are prevented from being performed in parallel, so that the processing period of time can be prevented from being lengthened.

Further, because the MFP 100 provides notification of progress of checking performed on the plurality of data pieces stored in the USB memory 118, the user can be informed of the progress of checking.

Further, because the MFP 100 provides notification of completion of checking in response to completion of checking performed on the plurality of data pieces stored in the USB memory 118, the user can be informed of when to detach the USB memory 118 from the MFP 100.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus to which an external storage device is attachable and from which the external storage device is detachable, comprising a hardware processor, wherein
the hardware processor,
in response to detection of attachment of the external storage device, checks presence of a computer virus in each of a plurality of data pieces stored in the external storage device,
determines a target data piece to be processed from among the plurality of data pieces stored in the external storage device, and
in response to determination of the target data piece while the plurality of data pieces stored in the external storage device are being checked, checks presence of a computer virus in such a manner that the target data piece is given a higher priority than other data pieces.

2. The image forming apparatus according to claim 1, wherein
the hardware processor further
determines an order, in which the plurality of data pieces stored in the external storage device are checked, according to a risk level of each of the plurality of data pieces stored in the external storage device, and
checks presence of a computer virus in the plurality of data pieces stored in the external storage device in the determined order.

3. The image processing apparatus according to claim 2, wherein
the risk level is a value that is predetermined with respect to an attribute of a data piece stored in the external storage device.

4. The image processing apparatus according to claim 3, wherein
the hardware processor does not check presence of a computer virus in a data piece having the attribute corresponding to a risk level indicating no risk of including a computer virus among the plurality of data pieces stored in the external storage device.

5. The image forming apparatus according to claim 3, wherein
the risk level is downloaded from outside together with a definition file for detecting presence of a computer virus.

6. The image forming apparatus according to claim 3, wherein
the hardware processor further changes an order, in which data pieces are checked for presence of a computer virus, based on the attribute of a data piece in which a computer virus has been detected in the past.

7. The image forming apparatus according to claim 2, wherein
the hardware processor determines the order, in which a plurality of data pieces which are stored in the external storage device and have a same risk level are checked, according to update dates and points in time.

8. The image forming apparatus according to claim 2, wherein
the hardware processor further provides a warning in response to detachment of the external storage device before checking for presence of a computer virus in the plurality of data pieces stored in the external storage device is completed.

9. The image forming apparatus according to claim 8, wherein
the hardware processor provides a warning in the case where the risk level of a data piece, that has not been checked for presence of a computer virus and is among the plurality of data pieces stored in the external storage device, is equal to or higher than a certain threshold value.

10. The image forming apparatus according to claim 2, wherein
the hardware processor further provides notification of prohibition of an operation of detaching the external storage device while the risk level of a data piece, that has not been checked for presence of a computer virus and is among the plurality of data pieces stored in the external storage device, is equal to or higher than a certain threshold value.

11. The image forming apparatus according to claim 1, further comprising an inner storage device storing a data piece, wherein
the hardware processor, in the case where a process of storing the target data piece in the inner storage device is executed, does not check presence of a computer virus in the target data piece.

12. The image forming apparatus according to claim 1, wherein
the hardware processor checks a data piece, that has not been checked for presence of a computer virus and is among the plurality of data pieces stored in the external storage device, after a process is executed on the target data piece.

13. The image forming apparatus according to claim 1, wherein
the hardware processor checks the target data piece after finishing checking a data piece, which is being checked at a point in time at which the target data piece is determined and is among the plurality of data pieces stored in the external storage device.

14. The image forming apparatus according to claim 1, wherein
the hardware processor further provides notification of progress of checking for presence of a computer virus in the plurality of data pieces stored in the external storage device.

15. The image forming apparatus according to claim 1, wherein
the hardware processor provides notification of completion of checking for presence of a computer virus in response to completion of checking for presence of a computer virus in the plurality of data pieces stored in the external storage device.

16. A virus checking method executed in an image forming apparatus to which an external storage device is attachable and from which the external storage device is detachable,
the virus check method including:
a checking step of checking presence of a computer virus in each of a plurality of data pieces stored in the external storage device in response to detection of attachment of the external storage device; and
a target determining step of determining a target data piece to be processed from among the plurality of data pieces stored in the external storage device, wherein
the checking step includes checking presence of a computer virus in such a manner that the target data piece is given a higher priority than other data pieces, in response to determination of the target data piece while the plurality of data pieces stored in the external storage device are being checked.

17. A non-transitory computer-readable recording medium encoded with a virus checking program executed in a computer controlling an image forming apparatus to which an external storage device is attachable and from which the external storage device is detachable,
the virus checking program causing the computer to execute:
a checking step of checking presence of a computer virus in each of a plurality of data pieces stored in the external storage device in response to detection of attachment of the external storage device; and
a target determining step of determining a target data piece to be processed from among the plurality of data pieces stored in the external storage device, wherein
the checking step includes checking presence of a computer virus in such a manner that the target data piece is given a higher priority than other data pieces, in response to determination of the target data piece while the plurality of data pieces stored in the external storage device are being checked.
